(19) United States
(12) Patent Application Publication
(10) Pub. No.: US 2022/0048361 A1
(43) Pub. Date: Feb. 17, 2022

(54) AIR-CONDITIONING CONTROL SYSTEM AND AIR-CONDITIONING CONTROL METHOD

(71) Applicant: Toyota Jidosha Kabushiki Kaisha, Toyota-shi Aichi-ken (JP)

(72) Inventors: Kenichi Yanagida, Nagoya-shi (JP); Tomoya Yamaguchi, Seto-shi (JP); Kenji Tadakuma, Toyota-city (JP)

(21) Appl. No.: 17/374,355

(22) Filed: Jul. 13, 2021

(30) Foreign Application Priority Data
Aug. 11, 2020 (JP) 2020-136008

(51) Int. Cl. B60H 1/00

(52) U.S. Cl. CPC B60H 1/00742; B60H 1/00807; B60H 1/00785; B60H 1/0075

(57) ABSTRACT

An air-conditioning control system includes a memory, a processor coupled to the memory, and an air-conditioner for a space, wherein the processor is configured to acquire user information that includes any future increase or decrease in a number of users inside the space as a result of input by a user, and to control the air-conditioner for the space based on the user information before there is a change in the number of users inside the space.

### CROSS-REFERENCE TO RELATED APPLICATION

This application is based on and claims priority under 35 USC 119 from Japanese Patent Application No. 2020-136008 filed on Aug. 11, 2020, the disclosure of which is incorporated by reference herein in its entirety.

### BACKGROUND

### Technical Field

The present disclosure relates to an air-conditioning control system and an air-conditioning control method.

### Related Art

An air-conditioner for a vehicle is disclosed in Japanese Unexamined Patent Application Laid-Open (JP-A) No. 2009-051364. In this air-conditioner for a vehicle, the number of passengers in a vehicle cabin is estimated, and the air-conditioner is controlled in accordance with this number.

However, in this related art, because the number of passengers in a vehicle is estimated by detecting the concentration of carbon dioxide inside the vehicle cabin, there is room for improvement from the standpoint of performing air-conditioning control which takes into account future changes in the number of passengers in the cabin.

### SUMMARY

In consideration of the above-described circumstances, the present disclosure provides an air-conditioning control system and an air-conditioning control method that enable air-conditioning control which takes into account future changes in the number of passengers in a cabin to be performed.

An air-conditioning control system of a first aspect of the present disclosure includes a memory, a processor that is coupled to the memory, and an air-conditioner for a space. The processor is configured to acquire user information that includes any future increase or decrease in a number of users inside the space as a result of input by a user, and to control the air-conditioner for the space based on the user information before there is a change in the number of users inside the space.

An air-conditioning control system of the first aspect is provided with a memory, a processor that is coupled to the memory, and an air-conditioner. As a result of input by a user, the processor acquires user information that includes any future increase or decrease in a number of users inside the space. In addition, the processor controls the air-conditioner inside the space based on the acquired user information before there is a change in the number of users in the space.

An air-conditioning control system of a second aspect of the present disclosure is that, in the first aspect, the processor is configured to estimate sensory temperature of the users that are entering the space. Preference information of the users relating to air-conditioning is contained in the user information as a result of input by the users. The processor is able to control the air-conditioner based on the estimated sensory temperature of the users and on the preference information.

According to the air-conditioning control system of the second aspect, the sensory temperature of users that are entering the space is estimated by the processor. In addition, preference information of the users relating to air-conditioning is contained in the user information as a result of input by the users. Moreover, the processor is able to control the air-conditioner based on the estimated sensory temperature of the users and on the preference information.

An air-conditioning control system of a third aspect of the present disclosure is that, in the first aspect or second aspect, the processor is configured to acquire space external environment information that includes at least one of a temperature outside the space, a humidity outside the space, or an amount of solar radiation outside the space, and the processor is able to control the air-conditioner based on the space external environment information.

According to the air-conditioning control system of the third aspect, space external environment information that includes at least one of the temperature outside the space, the humidity outside the space, or the amount of solar radiation outside the vehicle cabin is acquired by the processor. Moreover, the processor is able to control the air-conditioner based on the space external environmental information.

An air-conditioning control system of a fourth aspect of the present disclosure is that, in any one of the first aspect through the third aspect, the processor is configured to acquire space internal environment information that includes at least one of a temperature inside the space, a humidity inside the cabin, or a volume of airflow supplied by the air-conditioner inside the space. In addition, at least one of an amount of clothing worn by the users or a metabolic rate of the users is contained in the user information, and the processor is able to control the air-conditioner based on the space internal environment information and the user information.

According to the air-conditioning control system of the fourth aspect, space internal environmental information that includes at least one of the temperature inside the space, the humidity inside the space, or the volume of airflow supplied by the air-conditioner inside the space is acquired by the processor. In addition, at least one of the amount of clothing worn by the users or the metabolic rate of the users is also acquired as user information. Accordingly, the processor is able to control the air-conditioner based on the acquired space internal environment information and on the user information.

An air-conditioning control system of a fifth aspect of the present disclosure is that, in any one of the first aspect through the fourth aspect, the processor is configured to estimate changes in a temperature inside the space based on space internal environment information, space external environment information, and the user information. Accordingly, the processor is able to control the air-conditioner based on the estimated changes in the temperature inside the space.

An air-conditioning control system of a sixth aspect of the present disclosure is that, in any one of the first aspect through the fifth aspect, the space is a vehicle cabin, the users are vehicle passengers, and the air conditioner is disposed for the vehicle cabin.

An air-conditioning control method of a seventh aspect of the present disclosure is a method in which a processor that is coupled to a memory is configured to acquire user information that includes any future increase or decrease in a number of users inside a space as a result of input by a user, and to control the air-conditioner for the space based on the user information before there is a change in the number of users in the space.

According to the air-conditioning control method of the seventh aspect, the processor is configured to acquire user information that includes any future increase or decrease in the number of users inside a space, and to control the air-conditioner for the space based on the user information before there is a change in the number of users in the space.

As has been described above, the air-conditioning control system of the first aspect has the effect that it is possible to perform air-conditioning control which takes into account future changes in the number of users in a space.

The air-conditioning control system of the second aspect has the effect that it is possible to make the air-conditioning inside the space more comfortable for the users inside the space.

The air-conditioning control system of the third aspect has the effect that it is possible to adjust the air-conditioning inside the space in accordance with conditions outside the space.

The air-conditioning control system of the fourth aspect has the effect that it is possible to adjust the air-conditioning inside the space in accordance with conditions inside the space and with the state of the users inside the space.

The air-conditioning control system of the fifth aspect has the effect that it is possible to adjust the air-conditioning inside the space in accordance with estimated changes in the temperature inside the space.

The air-conditioning control system of the sixth aspect has the effect that it is possible to adjust the air-conditioning inside the vehicle cabin in accordance with conditions outside and inside the vehicle cabin and with the state of the users inside the vehicle cabin.

The air-conditioning control method of the seventh aspect has the effect that it is possible to perform air-conditioning control which takes into account future changes in the number of passengers in a space.

### BRIEF DESCRIPTION OF THE DRAWINGS

Embodiments will be described in detail based on the following figures, wherein:

FIG. 1 is an explanatory diagram schematically showing a structure of an air-conditioning control system according to a first exemplary embodiment;

FIG. 2 is a block diagram showing a hardware structure on a vehicle side in the air-conditioning control system according to the first exemplary embodiment;

FIG. 3 is a block diagram showing a functional structure of the air-conditioning control system according to the first exemplary embodiment; and

FIG. 4 is an explanatory diagram schematically showing a structure of an air-conditioning control system according to a second exemplary embodiment.

### DETAILED DESCRIPTION

### First Exemplary Embodiment

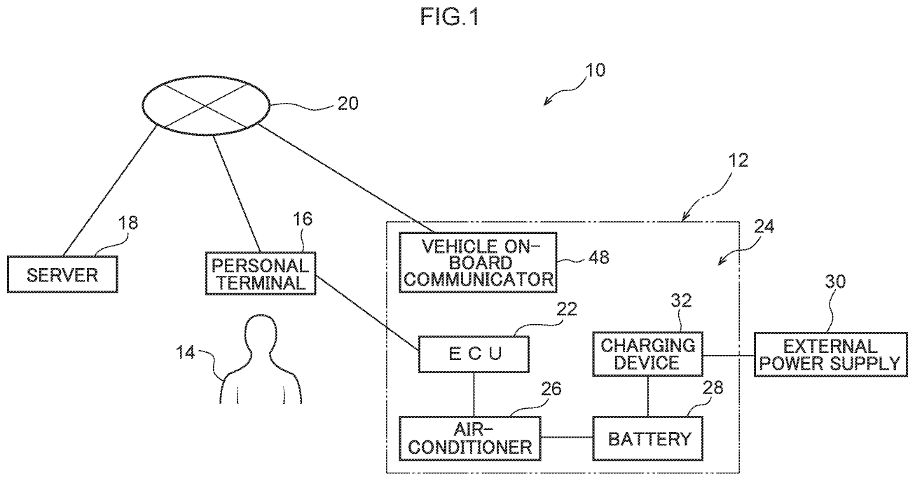

Hereinafter, a first exemplary embodiment of an air-conditioning control system according to the present disclosure will be described using FIG. 1 through FIG. 3. As is shown in FIG. 1, an ‘air-conditioning control system for a vehicle 10’ is formed so as to include a vehicle 12, a personal terminal 16 that is carried by a user 14 who is serving as a passenger using the vehicle 12, and a server 18. Note that the vehicle 12, the personal terminal 16, and the server 18 are connected together via a predetermined network 20.

As an example, the vehicle 12 is a shared car capable of being used by a car share service, and the vehicle 12 is provided with an ECU (Electrical Control Unit) 22, and an ‘air-conditioner 26’ that supplies an adjusted airflow to an interior of a ‘vehicle cabin 24’ of the vehicle 12. As is described below, the ECU 22 is able to control the air-conditioner 26 based on booking information transmitted from the server 18. Note that power from a battery 28 can be constantly supplied to the ECU 22 and the air-conditioner 26. In addition, power is also supplied to the battery 28 from an external power supply 30 via a charging device 32.

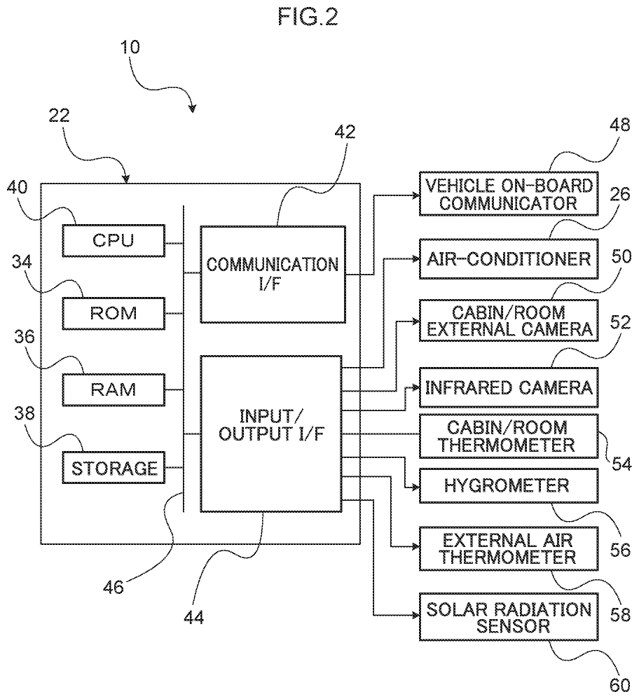

As is shown in FIG. 2, the ECU 22 is formed so as to include ROM (Read Only Memory) 34, RAM (Random Access Memory) 36, storage 38, a CPU (Central Processing Unit) 40, a communication interface 42, and an input/output interface 44. These component elements making up the ECU 22 are mutually connected via a bus 46 so as to be able to communicate with each other.

The ROM 34 stores various kinds of programs and various kinds of data, while the RAM 36 is able to temporarily store programs and data. Note that, as is described below, the RAM 36 functions as a work area for the CPU 40. The storage 38 is formed by an HDD (Hard Disk Drive) or an SSD (Solid State Drive) and stores various kinds of programs including an operating system and various kinds of data. In addition, programs and the like that are used to control the air-conditioner 26 are stored in the ROM 34 or the storage 38.

The CPU 40 is a central processing unit, and performs tasks such as executing various kinds of programs, and controlling various units. More specifically, the CPU 40 reads programs from the ROM 34 or from the storage 38 and executes these programs using the RAM 36 as a work area. The CPU 40 performs the control of the various component elements connected to the CPU 40 and of various types of computation processing in accordance with the programs stored in the ROM 34 or the storage 38.

The communication interface 42 is an interface that the vehicle 12 uses in order to communicate with the server 18, the personal terminal 16, and the other devices, and a

Standard such as, for example, Ethernet (Registered Trademark), LTE, FDDI, Wi-Fi (Registered Trademark) or the like is used for the communication interface 42. Note that a vehicle on-board communicator 48 is connected to the communication interface 42, and examples of the vehicle on-board communicator 48 include a DCM (Data Communication Module) or the like.

The air-conditioner 26, cabin external cameras 50, an infrared camera 52, a cabin thermometer 54, a hygrometer 56, an external air thermometer 58, and a solar radiation sensor 60 are electrically connected to the input/output interface 44.

The air-conditioner 26 is formed so as to include an HVAC (Heating, Ventilation, and Air-Conditioning) unit (not shown in the drawings) and, based on controls signals received from the ECU 22, is able to supply a temperature-adjusted airflow through a plurality of ventilation holes (not shown in the drawings) that are provided in the vehicle cabin 24.

More specifically, from the viewpoint of air-conditioning control, the interior of the vehicle cabin 24 is divided virtually into a plurality of areas, more specifically, a driver's seat area, a front passenger's seat area, and a rear passengers' seat area. The air-conditioner 26 is able to adjust the airflow volume and the set temperature and the like individually in each of these areas.

Note that, in the present exemplary embodiment, as an example, the air-conditioner 26 is provided with ventilation holes and a blend door (not shown in the drawings) for each of the aforementioned plurality of areas. By blending together an airflow from an evaporator (not shown in the drawings) side and an airflow from a heater core (not shown in the drawings) side using the blend door, the volume of air flowing through the ventilation holes and the set temperature and the like can be adjusted for each individual area.

Moreover, it is also possible for the air-conditioner 26 to be provided with an individual evaporator and heater core respectively for each of the aforementioned plurality of areas. In other words, it is also possible to employ a structure in which the vehicle 12 is provided with an individual air-conditioner respectively for each of the plurality of areas.

The external cameras 50 are able to capture images of areas outside the vehicle cabin 24, more specifically, of peripheral areas around the vehicle 12 including areas adjacent to side doors (not shown in the drawings) thereof. Plural external cameras 50 are disposed in positions where they are able to capture images of users 14 boarding the vehicle 12. Image data for the users 14 acquired by the external cameras 50 is transmitted to the ECU 22.

The infrared camera 52 is able to provide a visible image of infrared rays irradiating from an object within the areas around the outside of the vehicle cabin 24. This infrared camera 52 is used to measure the skin temperature of the users 14 boarding the vehicle 12. Measurement data acquired by the infrared camera 52 is transmitted to the ECU 22. Note that it is also possible for a non-contact type of infrared ray thermometer or the like to be used instead of the infrared camera 52.

The cabin thermometer 54 is able to measure a temperature inside the vehicle cabin 24, while the hygrometer 56 is able to measure a humidity inside the vehicle cabin 24, and the external air thermometer 58 is able to measure an external air temperature around the vehicle 12. Measurement data acquired by each of the cabin thermometer 54, the hygrometer 56, and the external air thermometer 58 is transmitted to the ECU 22.

The solar radiation sensor 60 is able to measure energy irradiated from the sun per unit time and per unit area. Measurement data acquired by the solar radiation sensor 60 is transmitted to the ECU 22.

The personal terminal 16 is provided with a CPU (not shown in the drawings), memory (not shown in the drawings), non-volatile storage (not shown in the drawings), and a network interface (not shown in the drawings) that is able to connect to the network 20, and based on operations performed by the user 14, is able to transmit booking information for the vehicle 12 to the server 18. Note that this booking information includes the time when usage of the vehicle 12 starts, the time when usage of the vehicle 12 ends, and identification information for the personal terminal 16 (in other words, a device ID). Note also that the device ID for the personal terminal 16 may also be regarded as being a personal ID for the user 14.

The personal terminal 16 is also capable of measuring a heartrate and a skin surface temperature of the user 14, and the resulting measurement values are transmitted to the server 18 at regular predetermined times.

The personal terminal 16 and the ECU 22 are also able to be paired together so as to be able to communicate with each other using a short-range wireless communication Standard such as, for example, Bluetooth (Registered Trademark) or the like. Setting contents such as the airflow volume and temperature and the like of the air-conditioner 26, in other words, air-conditioning setting data that are input via an operation performed by the user 14 are associated with the device ID of the personal terminal 16, and these are then stored in the server 18.

The server 18 is provided with a CPU (not shown in the drawings), memory (not shown in the drawings), a non-volatile storage portion (not shown in the drawings), and a network interface (not shown in the drawings) that can be connected to the network 20.

Programs that enable the server 18 to function are stored in the storage portion of the server 18. The CPU of the server 18 reads these programs from the storage portion and expands them in the memory and, as a result, is able to sequentially execute the processing contained in these programs. Note that this storage portion is formed so as to include an HDD or the like, and is able to store not only programs, but various other kinds of data as well.

The storage portion of the server 18 stores booking information for the vehicle 12, preference information of the user 14 relating to air-conditioning (described below), an sensory temperature prediction model (described below), and the heartrate and skin surface temperature of the user 14. Examples of the information stored in the server 18 include information items such as the external air temperature, the humidity, and the amount of solar irradiation and the like for various regions. Note that these various types of information that are accumulated in the server 18 are regularly updated in the server 18.

As a result of the CPU of the server 18 executing the various kinds of programs, the server 18 is able to perform communication processing with other devices via the network 20.

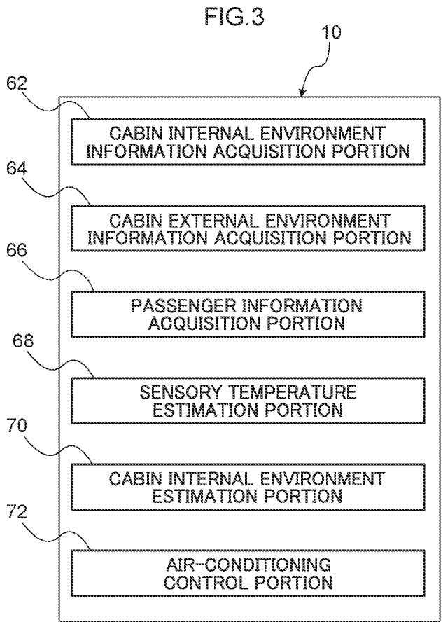

The air-conditioning control system for a vehicle 10 that is formed by the above-described hardware is able to perform various functions. Hereinafter, a functional structure of the air-conditioning control system for a vehicle 10 will be described using FIG. 3.

The air-conditioning control system for a vehicle 10 is formed so as to include, as functional elements, a ‘cabin internal environment information acquisition portion 62’, a ‘cabin external environment information acquisition portion 64’, a ‘passenger information acquisition portion 66’, a ‘sensory temperature estimation portion 68’, a ‘cabin internal environment estimation portion 70’, and an ‘air-conditioning control portion 72’. Note that each of these functional elements is implemented as a result of the CPU 40 reading and then executing a program stored in the ROM 34 or the storage 38.

The cabin internal environment information acquisition portion 62 acquires information about the environment inside the vehicle cabin 24. More specifically, the cabin internal environment information acquisition portion 62 acquires the cabin temperature measured by the cabin thermometer 54, and the humidity measured by the hygrometer 56. In addition, the cabin internal environment information acquisition portion 62 acquires information relating to the air-conditioning setting temperature, the airflow volume, and the operating state of the air-conditioner 26. Note that the operating state refers to a predetermined operating state of the air-conditioner 26, namely, whether the air-conditioner 26 is introducing external air into the vehicle cabin 24, or whether the air-conditioner 26 is internally circulating the air inside the vehicle cabin 24.

The cabin external environment information acquisition portion 64 acquires information about the external environment surrounding the vehicle 12. More specifically, the cabin external environment information acquisition portion 64 acquires the external air temperature around the periphery of the vehicle 12 measured by the external air thermometer 58, and the amount of solar radiation measured by the solar radiation sensor 60. In addition, the cabin external environment information acquisition portion 64 may also acquire information relating to the weather acquired by the server 18 via the communication interface 42.

The passenger information acquisition portion 66 acquires the personal information of the users 14, in other words, the amount of clothing worn by the users 14, the metabolic rate of the users 14, and any increase or decrease in the number of users 14 inside the vehicle cabin 24. More specifically, the passenger information acquisition portion 66 measures the amount of clothing from images of the users 14 captured by the external cameras 50. Note that, in the present exemplary embodiment, as an example, the amount of clothing is acquired as a thermal resistance ‘clo’ of the clothing.

In addition, the passenger information acquisition portion 66 calculates the metabolic rate of a user 14 based on the heartrate and skin surface temperature of the user 14 acquired by the personal terminal 16. The metabolic rate of a user 14 may also be calculated from the surface temperature of the skin of a user 14 that is measured by the infrared camera 52. In the present exemplary embodiment, as an example, the metabolic rate is acquired as a unit ‘met’ that takes as a reference an amount of heat per unit of body area of an adult having a standard physique who is seated quietly.

Furthermore, the passenger information acquisition portion 66 acquires booking information for all users 14 who are planning to use the vehicle 12 within a predetermined time period. In other words, the passenger information acquisition portion 66 acquires the number of users 14 in the vehicle cabin 24 at regular predetermined times.

In addition, the passenger information acquisition portion 66 acquires preference information of the users 14 relating to air-conditioning. Here, this preference information of the users 14 relating to air-conditioning refers to data in which the air-conditioning setting data selected by the users 14, the sensory temperature estimated values for the users 14 (described below) for the time when this air-conditioning setting data was input, and the device ID of the personal terminal 16 are mutually associated with each other. In other words, data relating to mutual correlations between the setting values for the air-conditioning of the users 14 and the sensory temperature estimated values for the users 14 is contained in the preference information of the users 14 relating to air-conditioning.

Based on the data acquired by the cabin internal environment information acquisition portion 62, the cabin external environment information acquisition portion 64, and the passenger information acquisition portion 66, the sensory temperature estimation portion 68 estimates the sensory temperatures of the users 14 who are about to board the vehicle 12 before they board the vehicle 12, and also the sensory temperatures of the users 14 who will have been on board the vehicle 12. The estimated sensory temperatures for the users 14 that have been estimated by the sensory temperature estimation portion 68 are transmitted to the server 18 at regular predetermined times.

As the sensory temperatures employed in the present exemplary embodiment, quantitative numerical values are employed in accordance with the information that is able to be acquired by the air-conditioning control system for a vehicle 10. For example, an operative temperature (OT), a corrected humid operative temperature (HOTV), and a standard new effective temperature (SET) and the like are used.

Based on the data acquired by the cabin internal environment information acquisition portion 62, the cabin external environment information acquisition portion 64, and the passenger information acquisition portion 66, and on the sensory temperature prediction model, the sensory temperature estimation portion 68 predicts a future sensory temperature of the users 14 inside the vehicle cabin 24 after a predetermined time will be elapsed.

Here, the sensory temperature prediction model is a collected data obtained by compiling data showing a relationship between the elapsed time and the sensory temperature of a predetermined test subject inside a predetermined test chamber in which a predetermined air-conditioning is continuously maintained. The data showing the relationship between the elapsed time and the sensory temperature of the predetermined test subject are compiled with respect to a variety of conditions of the test subjects and a variety of conditions within the test chamber. Note that the sensory temperature of a predetermined test subject is calculated based on measurement values for the temperature, humidity, radiant heat, and wind speed within a predetermined test chamber, as well as on the metabolic rate and amount of clothing of the predetermined test subject.

The cabin internal environment estimation portion 70 estimates the environment within the vehicle cabin 24 based on the data acquired by the cabin internal environment information acquisition portion 62, the cabin external environment information acquisition portion 64, and the passenger information acquisition portion 66. The cabin internal environment estimation portion 70 estimates a change of the amount of heat within the vehicle cabin 24 that will be caused, for example, by a future increase or decrease in the number of users 14 inside the vehicle cabin 24 which is acquired from the passenger information acquisition portion 66. The cabin internal environment estimation portion 70 also estimates a change of the temperature within the vehicle cabin 24 based on this change of the amount of heat.

The air-conditioning control portion 72 controls the air-conditioner 26 based on the preference information of the users 14 relating to air-conditioning acquired by the passenger information acquisition portion 66, on the future sensory temperature of the users 14 predicted by the sensory temperature estimation portion 68, and on the environment and the like within the vehicle cabin 24 estimated by the cabin internal environment estimation portion 70.

More specifically, based on the booking information acquired by the passenger information acquisition portion 66, the preference information of the users 14 relating to air-conditioning, and the metabolic rate and the like of the users 14 acquired by the passenger information acquisition portion 66, the air-conditioning control portion 72 operates the air-conditioner 26 in advance before the users 14 boards the vehicle 12, so as to adjust the air-conditioning condition inside the vehicle cabin 24 to be conformed to the preferences of the users 14.

More specifically, settings are implemented so that when booking information for the vehicle 12 is transmitted from the personal terminal 16 to the server 18, a signal based on that booking information is transmitted from the server 18 to the ECU 22. Settings are also implemented so that the ECU 22 controls the air-conditioner 26 so that a comfortable air-conditioning for the user 14 is created in the interior of the vehicle cabin 24 before the time when the usage of the vehicle 12 by that user 14 begins.

Note that settings are also implemented so that, in a case in which preference information of the users 14 relating to air-conditioning is not contained in the passenger information acquired by the passenger information acquisition portion 66, the air-conditioning control portion 72 controls the air-conditioner 26 so that a predetermined air-conditioning within the vehicle cabin 24 is created in accordance with the metabolic rate and the like of the user 14 (for example, a condition in which the sensory temperature estimated value for the user 14 is 26°) before the user 14 boards the vehicle 12.

Furthermore, based on the booking information acquired by the passenger information acquisition portion 66, the preference information of the users 14 relating to air-conditioning, and the condition within the vehicle cabin 24 estimated by the cabin internal environment estimation portion 70, once a user 14 who is the first to alight from the vehicle 12 has left the vehicle cabin 24, the air-conditioning control portion 72 adjusts the air-conditioner 26 so that the air-conditioning inside the vehicle cabin 24 conforms to the preferences of the users 14 remaining inside the vehicle cabin 24. In contrast, if a user 14 is already inside the vehicle cabin 24, then in a case in which a new user 14 boards the vehicle 12, the air-conditioning control portion 72 adjusts the air-conditioner 26 so that the temperature and the like inside the vehicle cabin 24 is maintained based on the metabolic rate of the new user 14 acquired by the passenger information acquisition portion 66, and on the condition inside the vehicle cabin 24 estimated by the cabin internal environment estimation portion 70.

In addition, based on the future sensory temperature and the like of the users 14 predicted by the sensory temperature estimation portion 68, the air-conditioning control portion 72 adjusts the air-conditioner 26 so that a state in which the air-conditioning inside the vehicle cabin 24 conforms to the preferences of the users 14 is maintained.

(Actions and Effects of the Present Exemplary Embodiment)

Actions and effects of the present exemplary embodiment will be described.

As is shown in FIG. 3, in the present exemplary embodiment the passenger information acquisition portion 66 and the air-conditioning control portion 72 are provided as functional elements of the air-conditioning control system for a vehicle 10. In the passenger information acquisition portion 66, passenger information that includes any future increase or decrease in the number of users 14 inside the vehicle cabin 24, in other words, booking information for the users 14 is acquired. Based on the acquired passenger information, the air-conditioning control portion 72 controls the air-conditioner 26 inside the vehicle cabin 24 before there is a change in the number of users 14 inside the vehicle cabin 24. Because of this, it is possible to perform air-conditioning control that takes into account future changes in the number of people inside the vehicle cabin 24.

Moreover, the sensory temperature estimation portion 68 is also provided as a functional element of the air-conditioning control system for a vehicle 10, and the sensory temperature of users 14 who is about to board the vehicle cabin 24 is estimated by the sensory temperature estimation portion 68. Additionally, preference information relating to air-conditioning of the users 14 who is about to board the vehicle cabin 24 is also acquired by the passenger information acquisition portion 66. The air-conditioning control portion 72 then controls the air-conditioner 26 based on the estimated sensory temperature of users 14 who is about to board the vehicle cabin 24, and the acquired preference information of the users 14. Because of this, in the present exemplary embodiment, it is possible to ensure that the air-conditioning inside the vehicle cabin 24 is more appropriate for the users 14 who is about to board the vehicle cabin 24.

Moreover, the cabin external environment information acquisition portion 64 is also provided as a functional element of the air-conditioning control system for a vehicle 10, and cabin external environment information for the outside of the vehicle cabin 24, including the air temperature outside the vehicle cabin, the humidity outside the vehicle cabin, and the amount of solar radiation outside the vehicle cabin, is acquired by the cabin external environment information acquisition portion 64. The air-conditioning control portion 72 then controls the air-conditioner 26 based on the acquired cabin external environment information. Because of this, it is possible to adjust the air-conditioning inside the vehicle cabin 24 in accordance with the conditions outside the vehicle cabin 24.

In addition, the cabin internal environment information acquisition portion 62 is also provided as a functional element of the air-conditioning control system for a vehicle 10, and cabin internal environment information for the vehicle cabin 24, including the temperature inside the vehicle cabin, the humidity inside the vehicle cabin, and the airflow volume from the air-conditioner 26, is acquired by the cabin internal environment information acquisition portion 62. The amount of clothing worn by the users 14 and the metabolic rate of the users 14 are also acquired by the passenger information acquisition portion 66. The air-conditioning control portion 72 then controls the air-conditioner 26 based on the acquired cabin internal environment information, and the acquired passenger information. Because of this, it is possible to adjust the air-conditioning inside the vehicle cabin 24 in accordance with conditions inside the vehicle cabin 24 and with the state of the users 14 inside the vehicle cabin 24.

### Second Exemplary Embodiment

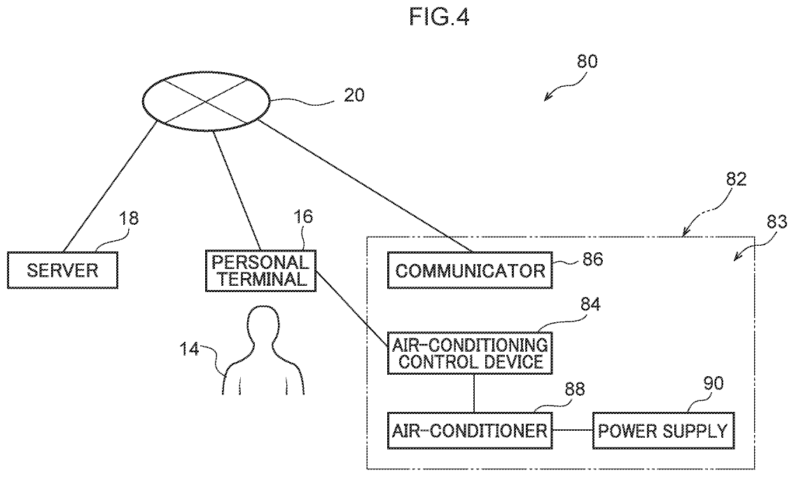

Hereinafter, a second exemplary embodiment of the air-conditioning control system according to the present disclosure will be described using FIG. 4. An ‘air-conditioning control system for a building 80’, which is serving as an air-conditioning control system according to the present exemplary embodiment, is formed so as to include a building 82, a personal terminal 16, and a server 18. Note that the building 82, the personal terminal 16, and the server 18 are connected together via a predetermined network 20.

An air-conditioning control device 84 that has the same functions as the ECU 22 as regards air-conditioning control is disposed in the building 82, and a communicator 86 installed in the building 82 is connected to a communication interface of the air-conditioning control device 84.

Plural seats (not shown in the drawing) are disposed in a shared space 83, which is serving as a room of the building 82, and an air-conditioning around each of the seats is adjusted by an ‘air-conditioner 88’. Although the structure of the air-conditioner 88 differs from that of the above-described air-conditioner 26, the air-conditioner 88 has the same functions as those of the air-conditioner 26. Moreover, both the air-conditioning control device 84 and the air-conditioner 88 are driven by power supplied from a power supply 90 that is installed in the building 82.

Room external cameras 50, an infrared camera 52, an external air thermometer 58, and a solar radiation sensor 60 are disposed at an entrance (not shown in the drawing) of the building 82, while a room thermometer 54 and a hygrometer 56 are disposed inside the building 82.

In the present exemplary embodiment, the booking information transmitted from the personal terminal 16 to the server 18 includes the time when usage of the seats in the shared space 83 started, and the time when usage of the seats in the shared space 83 ended. Note that the personal terminal 16 is able to be paired with the air-conditioning control device 84, and the air-conditioning control device 84 recognizes the personal terminal 16 as a result of the air-conditioning control device 84 being paired with the personal terminal 16. In addition, the airflow volume and set temperature and the like of the air-conditioner 88 are able to be set by the personal terminal 16 via the air-conditioning control device 84.

Furthermore, the air-conditioning control system for a building 80 having the above-described structure is provided with the same functional elements as the air-conditioning control system for a vehicle 10.

Because of this, in the air-conditioning control system for a building 80 according to the present exemplary embodiment, the air-conditioner 88 can be controlled in the same way as in the above-described air-conditioning control system for a vehicle 10. In other words, in the present exemplary embodiment, it is possible to control the air-conditioner 88 inside the shared space 83 before there is a change in the number of users 14 within the shared space 83 in the building 82. Because of this, in the present exemplary embodiment, it is possible to perform air-conditioning control that takes into account changes in the number of users within the shared space 83 in the building 82.

Moreover, in the present exemplary embodiment, it is also possible to adjust the air-conditioning so as to comply with the respective preferences of the users 14 who will use the seats in the shared space 83 in the building 82.

[Supplementary Description of the Above-Described Exemplary Embodiments]

(1) In the above-described exemplary embodiments, the external air temperature, the external humidity, and the amount of solar radiation outside the cabin/room are included in the external environment information, however, the present disclosure is not limited to this. In other words, it is also possible that, in accordance with the sensory temperature prediction model and the like that is being used, at least one of the external air temperature, the external humidity, and the amount of solar radiation outdid the cabin/room be included in the external environment information.

(2) Moreover, in the above-described exemplary embodiments, the internal temperature, the internal humidity, and the airflow volume of the air-conditioner are included in the cabin/room internal environment information, however, the present disclosure is not limited to this. In other words, it is also possible that, in accordance with the sensory temperature prediction model and the like that is being used, at least one of the internal temperature, the internal humidity, and the airflow volume of the air-conditioner for the cabin/room be included in the internal environment information.

(3) In addition, in the above-described exemplary embodiments, the metabolic rate of a user 14 is calculated using information of the user 14 that is acquired by the personal terminal 16, and the air-conditioning of the cabin/room interior is adjusted in advance, however, the present disclosure is not limited to this. For example, in a case in which a user 14 who has not already made a booking has indicated an intention to enter a cabin/room via the personal terminal 16 or the like, the seat for that user 14 can be specified using either the personal terminal 16 or a display device, and the air-conditioning around that seat can be adjusted based on data of the user 14 obtained by the external cameras 50 and the infrared camera 52 immediately before the user 14 enters the cabin/room.

(4) Moreover, in the above-described exemplary embodiments, the air-conditioning control system is provided with the cabin/room internal environment information acquisition portion 62, the cabin/room external environment information acquisition portion 64, the passenger information acquisition portion 66, the sensory temperature estimation portion 68, the cabin/room internal environment estimation portion 70, and the air-conditioning control portion 72 as functional elements, however, the present disclosure is not limited to this. In other words, in accordance with the specifications and the like of the air-conditioning control system, it is also possible to employ a structure in which the air-conditioning control system is provided only with the passenger information acquisition portion 66 and the air-conditioning control portion 72 as functional elements, or to employ a structure in which, in addition to these functional elements, at least one of the cabin/room internal environment information acquisition portion 62, the cabin/room external environment information acquisition portion 64, the sensory temperature estimation portion 68, and the cabin/room internal environment estimation portion 70 is provided.

(5) Furthermore, in addition to share cars, specific examples of vehicles to which the air-conditioning control system for a vehicle 10 according to the above-described embodiment can be applied also include buses and high-speed trains and the like. In addition, specific examples of various structures to which the air-conditioning control system for a building 80 according to the above-described embodiment can be applied include accommodation facilities and non-territorial offices and the like.

Exemplary embodiments of the present disclosure have been described above, however, the present disclosure is not limited to these. Various modifications and the like may be made to the present disclosure insofar as they do not depart from the scope of the present disclosure.

What is claimed is:

1. An air-conditioning control system comprising a memory, a processor coupled to the memory, and an air-conditioner for a space, wherein:
the processor is configured to:
acquire user information that includes any future increase or decrease in a number of users inside the space as a result of input by a user; and
control the air-conditioner for the space based on the user information before there is a change in the number of users inside the space.

2. The air-conditioning control system according to claim 1, wherein:
the processor is configured to estimate sensory temperature of users that are entering the space,
preference information relating to air-conditioning for the users is contained in the user information as a result of input by the user, and
the processor is able to control the air-conditioner based on the estimated sensory temperature of the users and on the preference information.

3. The air-conditioning control system according to claim 1, wherein:
the processor is configured to acquire space external environment information that includes at least one of a temperature outside the space, a humidity outside the space, or an amount of solar radiation outside the space; and
the processor is able to control the air-conditioner based on the space external environment information.

4. The air-conditioning control system according to claim 2, wherein:
the processor is configured to acquire space external environment information that includes at least one of a temperature outside the space, a humidity outside the space, or an amount of solar radiation outside the space; and
the processor is able to control the air-conditioner based on the space external environment information.

5. The air-conditioning control system according to claim 1, wherein:
the processor is configured to acquire space internal environment information that includes at least one of a temperature inside the space, a humidity inside the space, or a volume of airflow supplied by the air-conditioner inside the space,
at least one of an amount of clothing worn by the users or a metabolic rate of the users is contained in the user information, and
the processor is able to control the air-conditioner based on the space internal environment information and the user information.

6. The air-conditioning control system according to claim 2, wherein:
the processor is configured to acquire space internal environment information that includes at least one of a temperature inside the space, a humidity inside the space, or a volume of airflow supplied by the air-conditioner inside the space,
at least one of an amount of clothing worn by the users or a metabolic rate of the users is contained in the user information, and
the processor is able to control the air-conditioner based on the space internal environment information and the user information.

7. The air-conditioning control system according to claim 3, wherein:
the processor is configured to acquire space internal environment information that includes at least one of a temperature inside the space, a humidity inside the space, or a volume of airflow supplied by the air-conditioner inside the space,
at least one of an amount of clothing worn by the users or a metabolic rate of the users is contained in the user information, and
the processor is able to control the air-conditioner based on the space internal environment information and the user information.

8. The air-conditioning control system according to claim 1, wherein:
the processor is configured to estimate changes in a temperature inside the space based on space internal environment information, space external environment information, and the user information, and
the processor is able to control the air-conditioner based on the estimated changes in the temperature inside the space.

9. The air-conditioning control system according to claim 2, wherein:
the processor is configured to estimate changes in a temperature inside the space based on space internal environment information, space external environment information, and the user information, and
the processor is able to control the air-conditioner based on the estimated changes in the temperature inside the space.

10. The air-conditioning control system according to claim 3, wherein:
the processor is configured to estimate changes in a temperature inside the space based on space internal environment information, space external environment information, and the user information, and
the processor is able to control the air-conditioner based on the estimated changes in the temperature inside the space.

11. The air-conditioning control system according to claim 1, wherein the space is a vehicle cabin, the users are vehicle passengers, and the air-conditioner is disposed for the vehicle cabin.

12. An air-conditioning control method in which a processor that is coupled to a memory is configured to:
acquire user information that includes any future increase or decrease in a number of users inside a space as a result of input by a user; and
control an air-conditioner for the space based on the user information before there is a change in the number of users inside the space.
